(19) United States
(12) Patent Application Publication
(10) Pub. No.: US 2019/0204856 A1
(43) Pub. Date: Jul. 4, 2019

(54) GOODS TRANSPORTING SYSTEM WITH AN AERIAL MACHINE AND GOODS TRANSPORTING METHOD USING AN AERIAL MACHINE

(71) Applicant: Cheng-Ying Weng, Taipei City (TW)

(72) Inventors: Cheng-Ying Weng, Taipei City (TW); Hsiang-Tien Wu, Taipei City (TW)

(73) Assignee: Cheng-Ying Weng, Taipei City (TW)

(21) Appl. No.: 16/214,463

(22) Filed: Dec. 10, 2018

(30) Foreign Application Priority Data
Dec. 28, 2017 (CN) 201711459118.0

(51) Int. Cl. G05D 1/10; B64C 39/02; B64D 1/02; G06Q 10/08

(52) U.S. Cl. CPC G05D 1/101; B64C 39/024; B64C 2201/066; G06Q 10/08355; B64C 2201/128; B64D 1/02

(57) ABSTRACT

A goods transporting system with aerial machines utilizes instantaneous collection of location information and future moving path planning information of multiple ground and/or surface vehicles to pair with the delivery path of the goods. The aerial machine can be parked on the selected ground and/or the surface vehicle in the path of taking and transporting the goods, thereby saving power consumption of the aerial machine and effectively extending the transport distance for the goods.

### CROSS-REFERENCE TO RELATED APPLICATIONS

This application is based upon and claims priority under 35 U.S.C. 119 from China Patent Application No. 201711459118.0 filed on Dec. 28, 2017, which is hereby specifically incorporated herein by this reference thereto.

### BACKGROUND OF THE INVENTION

### 1. Field of the Invention

The present invention relates to a goods transporting system and a goods transporting method, especially to a goods transporting system with an aerial machine and a goods transporting method using an aerial machine.

### 2. Description of the Prior Arts

With the advancement of technology, automated equipment is gradually replacing the existing manpower to reduce the chances of accidents that may occur in the use of manpower for hazardous work, and to reduce the risk of health loss when using labor to work intensively. Take the delivery of goods as an example, especially in densely populated cities, where locomotives or bicycle expresses are a quick way to transport goods between locations, but it is quite dangerous for locomotives or bicycles across the traffic in time. If the user uses a truck to transport goods, traffic jams and parking problems are often encountered. Shipping goods not only consumes a lot of physical strength, but also long-term handling of goods may cause damage to muscles or joints. Therefore, the drone technology that has been gradually developed in recent years has become one of the methods for solving the aforementioned problems in the freight industry.

The drone is moved in a flight manner, so it is not affected by the traffic jam, and can directly reach the desired location. There is also no need to consider the parking problem, and there is no manpower loss during the transportation, so the above problems can be solved. However, the drone is powered by the battery itself. When the battery is too small, the power is insufficient, and the flight distance is limited. Although more batteries can provide more power and extend the flight distance, but relatively increase the weight and volume, and relatively reduce the weight and volume of the unmanned aircraft can carry goods. Thus, there are still many problems to be overcome when using drones to transport goods.

To overcome the shortcomings, the present invention provides a goods transporting system with an aerial machine and a goods transporting method using an aerial machine to mitigate or to obviate the aforementioned problems.

### SUMMARY OF THE INVENTION

The main objective of the present invention is to provide a goods transporting system with an aerial machine and a goods transporting method using an aerial machine. The goods transporting system with aerial machines utilizes instantaneous collection of location information and future moving path planning information of multiple ground and/or surface vehicles to pair with the delivery path of the goods. The aerial machine can be parked on the selected ground and/or the surface vehicle in the path of taking and transporting the goods, thereby saving power consumption of the aerial machine and effectively extending the transport distance for the goods.

Other objectives, advantages and novel features of the invention will become more apparent from the following detailed description when taken in conjunction with the accompanying drawings.

### BRIEF DESCRIPTION OF THE DRAWINGS

FIG. 1A is an illustrative view of a goods transporting system with a aerial machine in accordance with the present invention;

FIG. 1B is another illustrative view of the goods transporting system in FIG. 1;

FIG. 2A is a flowchart of a first embodiment of a goods transporting method using an aerial machine in accordance with the present invention;

FIG. 2B is a flowchart of a second embodiment of a goods transporting method using an aerial machine in accordance with the present invention;

FIG. 3 is flowchart of a re-planning step of a goods transporting method using an aerial machine in accordance with the present invention;

FIG. 4A is an operational illustrative view in a first situation of executing the goods transporting method using an aerial machine in accordance with the present invention;

FIG. 4B is an operational illustrative view in a second situation of executing the goods transporting method using an aerial machine in accordance with the present invention;

FIG. 5A is an operational illustrative view in a third situation of executing the goods transporting method using an aerial machine in accordance with the present invention;

FIG. 5B is an operational illustrative view in a fourth situation of executing the goods transporting method using an aerial machine in accordance with the present invention;

FIG. 6 is an operational illustrative view in a fifth situation of executing the goods transporting method using an aerial machine in accordance with the present invention;

FIG. 7 is an operational illustrative view in a sixth situation of executing the goods transporting method using an aerial machine in accordance with the present invention; and

FIG. 8 is an operational illustrative view in a seventh situation of executing the goods transporting method using an aerial machine in accordance with the present invention.

### DETAILED DESCRIPTION OF THE EMBODIMENTS

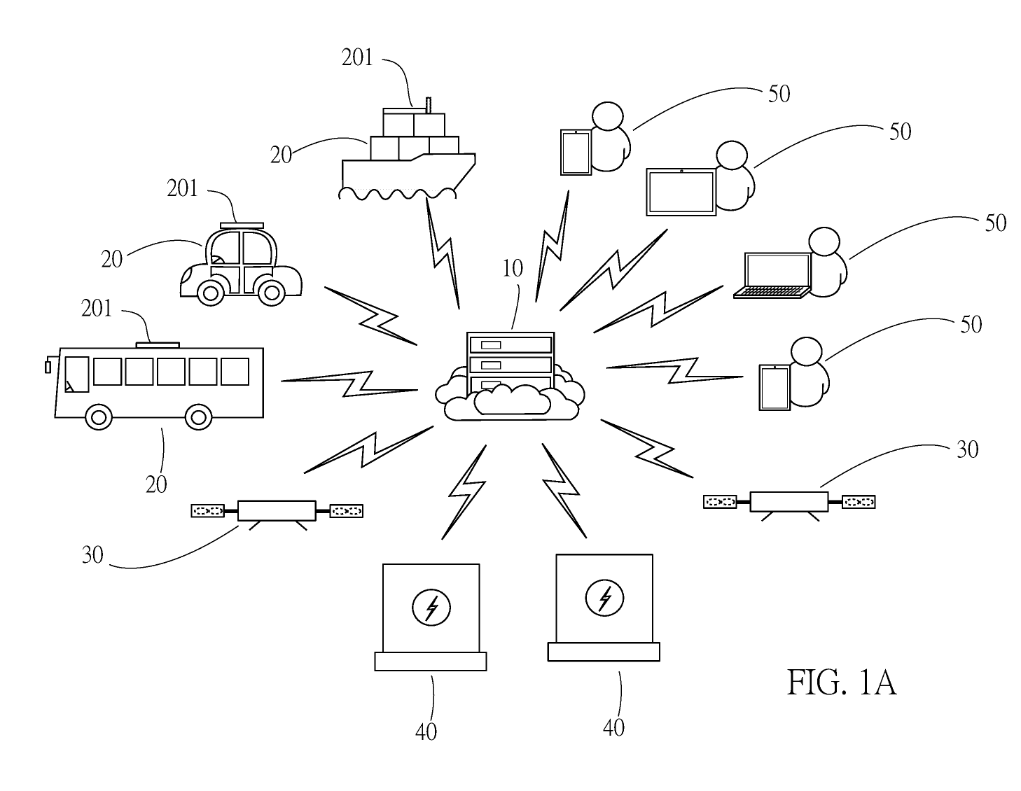

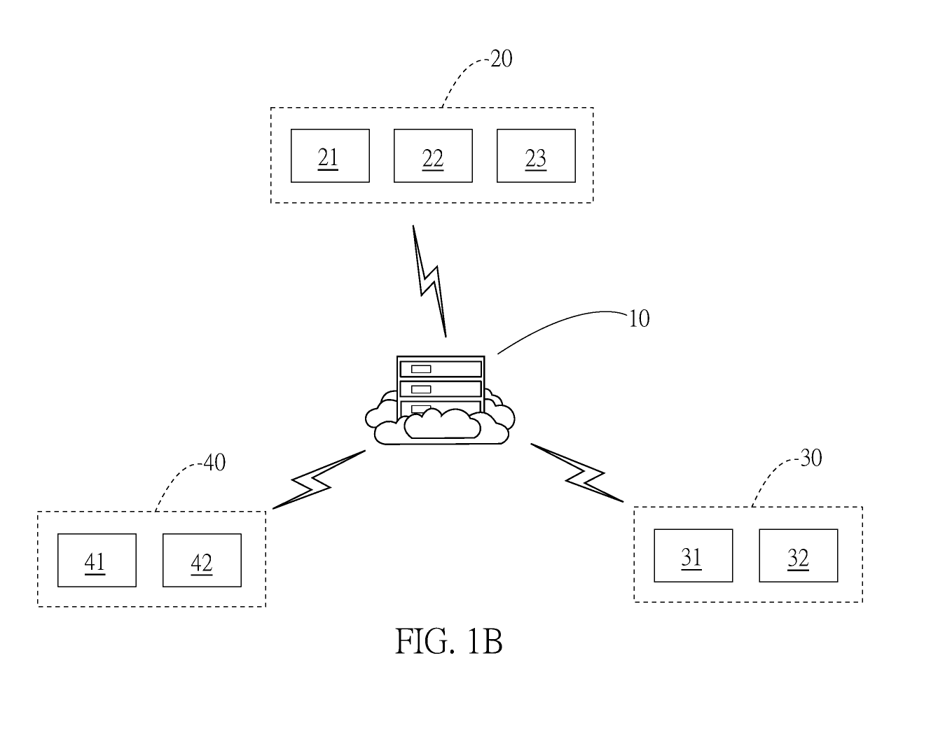

With reference to FIGS. 1A and 1B, a goods transporting system with a aerial machine in accordance with the present invention comprises a sever 10, multiple ground and/or surface vehicles 20 multiple aerial machines 30 and multiple charging stations 40.

The ground and/or surface vehicles 20 may be any vehicles moving on the road and/or on the water such as motorcycles, cars, buses, trucks, speedboats, freighters, ships, amphibious vehicles and so on. Each ground and/or surface vehicle 20 has a navigation module 21 and a communication module 22. The navigation module 21 has components like a GPS, an inertial sensor and so on to instantaneously collect the location information and future moving path planning information of the ground and/or surface vehicles 20. The communication module 22 provides the information instantaneously to the sever 10. Each ground and/or the surface vehicle 20 has a positioning device 201 for parking the aerial machines 30. Each ground and/or the surface vehicle 20 further has a charging module 23 to charge the aerial machines 30 while the aerial machines 30 park on the ground and/or the surface vehicles 20. The ground and/or the surface vehicles 20 move freely. The moving path of the ground and/or the surface vehicles 20 are controlled by the drivers and are not controlled by the sever 10. In one embodiment, the ground and/or the surface vehicles 20 cooperates with an operator providing the services of the present invention, and the ground and/or the surface vehicles 20 provide their location information and future moving path planning information to the server 10. The operator then rewards with the use of the ground and/or the surface vehicles 20.

The aerial machines 30 may be any vehicle that moves in the air, such as a drone, etc. Each aerial machine 30 has a navigation module 31 and a communication module 32. The navigation module 31 has components like a GPS, an inertial sensor and so on to instantaneously collect the location information and future moving path planning information of the aerial machines 30. The communication module 32 provides the information instantaneously to the sever 10. In one embodiment, when the distance between one of the ground and/or the surface vehicles 20 and one of the aerial machines 30, such as thirty meters but not limited to, the communication module 32 of the aerial machine 30 directly contact the communication module 22 of the ground and/or the surface vehicle 20 to provide location information to each other, thereby facilitating the aerial machine 30 to be parked on the ground and/or surface vehicle 20. When the aerial machines 30 are not used, the aerial machines 30 can be parked at any predetermined locations, such as a distribution center 101, one of the charging stations 40 and so on.

The charging stations 40 are disposed within a range of services provided by the system of the present invention. Each charging station 40 has a positioning device for parking at least one aerial machine 30. The positioning device may has a charging module 41 to charge the aerial machines 30 while the aerial machines 30 park on the positioning device of the charging station 40. In one embodiment, each charging station 40 has a communication module 42 to provide the status information of the charging station 40 to the server 10, such as the power supply status, occupied by the aerial machine 30 or not and so on. In one embodiment, when the ground and/or the surface vehicles 20 park stop moving and are parked on a roadside, a parking lot, a shore, or a dock, they can also be opened as a charging station via setting.

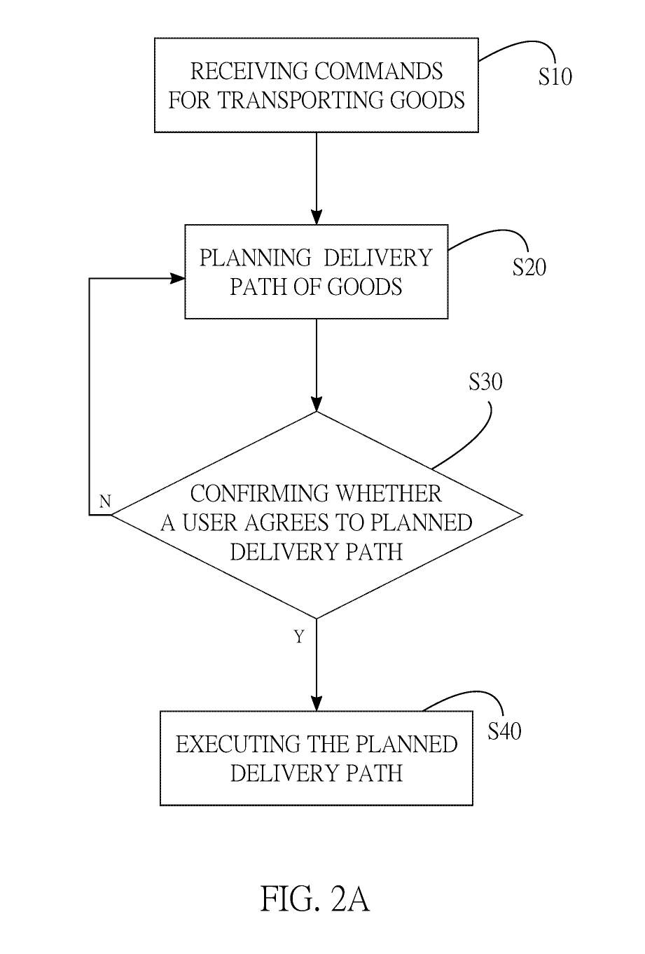

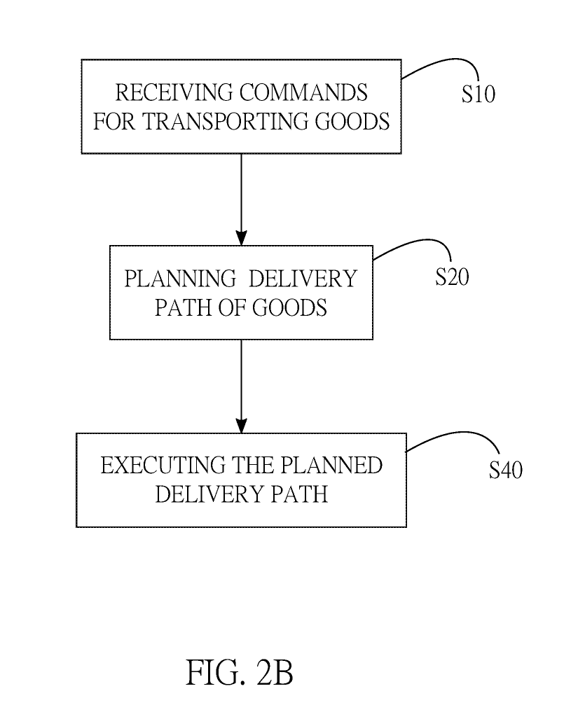

With reference to FIGS. 1A and 2A, a goods transporting method with aerial machines in accordance with the present invention comprises following steps.

Receiving commands for transporting goods (S10): The user 50 informs the server 10 of the need for goods transporting. The user 50 may inform the server 10 by different ways, such as a network communication, voice communication and so on. More specifically, the user 50 may inform the sever 10 of the need for goods transporting by website, mobile application, voice message and so on. The server 10 may be authenticated the identity and payment information of the user 50 for subsequent expenses. The content of the demand provided by the user 50 may include the weight of the goods, the size of the goods, the location of the goods, the place of delivery of the goods, the time specified for taking the goods, the delivery time, and the like.

Planning a delivery path of the goods (S20): The server 10 plans a delivery path of the goods based on the need of the user 50, and then pairs the delivery path to the received moving paths of the ground and/or surface vehicles 20. Thus, the delivery path of the goods includes a moving path of at least one selected ground and/or surface vehicle 20 and a moving path of an aerial machine 30. The moving path of the aerial machine 30 at least partially overlaps the moving path of the at least one selected ground and/or surface vehicle 10. After paring, a scheduled time for the aerial machine 30 to take the goods and a scheduled time for the goods to be delivered. Specifically, an optimal delivery path is planned between the three locations where the pick up location of the goods, where the destination for transporting the goods and the nearest aerial machine 30. In the optimal delivery path, the aerial machine 30 parks on the at least one selected ground and/or surface vehicle 20, which has a moving path overlaps with the optimal delivery path to reduce the flying distance of the aerial machine 30. Therefore, the power consumption of the aerial machine 30 is minimized.

Confirming whether the user 50 agrees to a delivery plan (S30): A delivery plan is transmitted to the user 50 to confirm whether the user 50 agrees to the delivery plan. In one embodiment, the delivery plan includes the planned delivery path, the time to pick up the goods, the time to deliver the goods, the cost and so on. If the user 50 agrees, then a following step is executed. If the user 50 disagrees, then the step S20 is executed to re-plan the delivery path. In one embodiment, the user 50 may input the disagree part in a menu when the user 50 disagrees to the delivery plan, such as disagreeing with the planned delivery path and further inputting a desired delivery path, disagreeing with the pick up time or the delivery time of the goods and further inputting a desired time, disagreeing with the cost and further inputting a desired cost, and so on. Then the planned delivery path is based on the requirement input by the user 50 when the step S20 is executed again. The aforementioned input content may be a range or a specific value, or a predetermined menu for the user to select. For example, the time can be selected in advance or delayed in units of thirty minutes, and the cost can be selected for reducing or increasing in an integer value, but not limited thereto. Since the planned delivery path is paired to the moving path of the at least one ground and/or surface vehicle 20, the time that the aerial machine 30 meets the at least one ground and/or surface vehicle 20 may be exceeded. Thus, in one embodiment, the time for the server 10 to wait for the user 50 to reply must be set to be shorter, such as 60 seconds or 120 seconds, but not limited thereto. If the set time is exceeded, it is considered that the user 50 disagrees to the delivery plan.

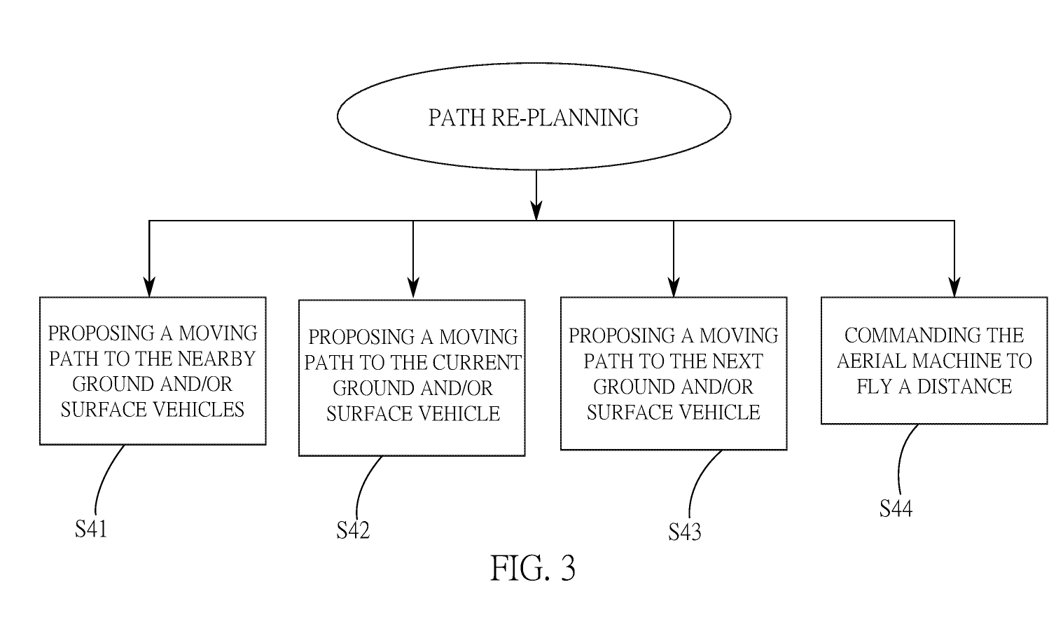

Executing the planned delivery path of the goods (S40): The server 10 transmits the commands to the selected aerial machine 30. Then the aerial machine 30 begins to execute the planned delivery path of the goods in the step S20. During the aerial machine 30 executes the planned delivery path, the aerial machine 30 parks on the at least one selected ground and/or surface vehicle 20 in at least partially path so that the aerial machine 30 accomplishes partial planned delivery path by the movement of the at least one ground and/or surface vehicle 20. In one embodiment as shown in FIG. 3, if one of the at least one selected ground and/or surface vehicle 20 cannot move along the original moving path or time when the step S40 is executed, the server 10 may execute the step S20 to pair the moving paths again, or may execute following steps (but not limited thereto). Step S41: The sever 10 may propose a moving path to a nearby ground and/or surface vehicle 20. If the nearby ground and/or surface vehicle 20 agrees to the proposed moving path, the nearby ground and/or surface vehicle 20 moves along the proposed moving path to compensate for the original moving path that the selected ground and/or surface vehicle 20 cannot move along. Step S42: The sever 10 may propose a moving path to the current ground and/or surface vehicle 20. If the current ground and/or surface vehicle 20 agrees to the proposed moving path, the current ground and/or surface vehicle 20 moves along the proposed moving path to compensate for the original moving path that the selected ground and/or surface vehicle 20 cannot move along. Step S43: The sever 10 may propose a moving path to a next ground and/or surface vehicle 20. If the next ground and/or surface vehicle 20 agrees to the proposed moving path, the next ground and/or surface vehicle 20 moves along the proposed moving path to compensate for the original moving path that the selected ground and/or surface vehicle 20 cannot move along. Step S44: The sever 10 demands the aerial machine 30 to fly along a proposed path to compensate for the original moving path that the selected ground and/or surface vehicle 20 cannot move along.

In one embodiment as shown in FIG. 2B, the server 10 do not provide the delivery plan for the user 50 to confirm. The user 50 needs to input a complete requirement in the step S10 and cannot change it. After the delivery path is planned in the step S20, the step S40 is entered to execute the planned delivery path. The conditions of the cost, the time to pick up and to deliver the goods and so on may be set up based on the requirement that the user 50 inputs, or may provide different options for the user 50 to decide.

In addition, the sever 10 plans a return path of the aerial machine 30 after the goods is delivered. The server 10 pairs the return path to the received moving paths of the ground and/or surface vehicles 20. Thus, the return path of the goods includes a moving path of at least one selected ground and/or surface vehicle 20 and a moving path of the aerial machine 30. The moving path of the aerial machine 30 at least partially overlaps the moving path of the at least one selected ground and/or surface vehicle 10. Specifically, an optimal return path is planned between the two locations of the aerial machine 30 and a docking location where the aerial machine 30 is expected to be parked. In the optimal return path, the aerial machine 30 parks on the at least one selected ground and/or surface vehicle 20, which has a moving path overlaps with the optimal return path to reduce the flying distance of the aerial machine 30. Therefore, the power consumption of the aerial machine 30 is minimized. The docking location where the aerial machine 30 is expected to be parked may be the distribution center 101, the charging stations 40, the ground and/or surface vehicles 20 that park on the roadside or on the shore and so on.

With the system and the method as described, the server 10 pairs the moving paths of the ground and/or surface vehicles 20 and the planned delivery path of the goods so that the most of the planned delivery path of the aerial machine 30 are complete by the selected ground and/or surface vehicles 20 carrying the aerial machine 30. Then the aerial machine 30 completes the delivery of the goods with minimal power consumption. Thus, the distance for the aerial machine 30 to transport the goods is effectively extended.

The following is a specific illustration of various embodiments of the present invention, which are described in various situations that may occur. The following description is only some embodiments of the present invention, and does not impose any form limitation on the present invention.

### Ordinary Embodiment I

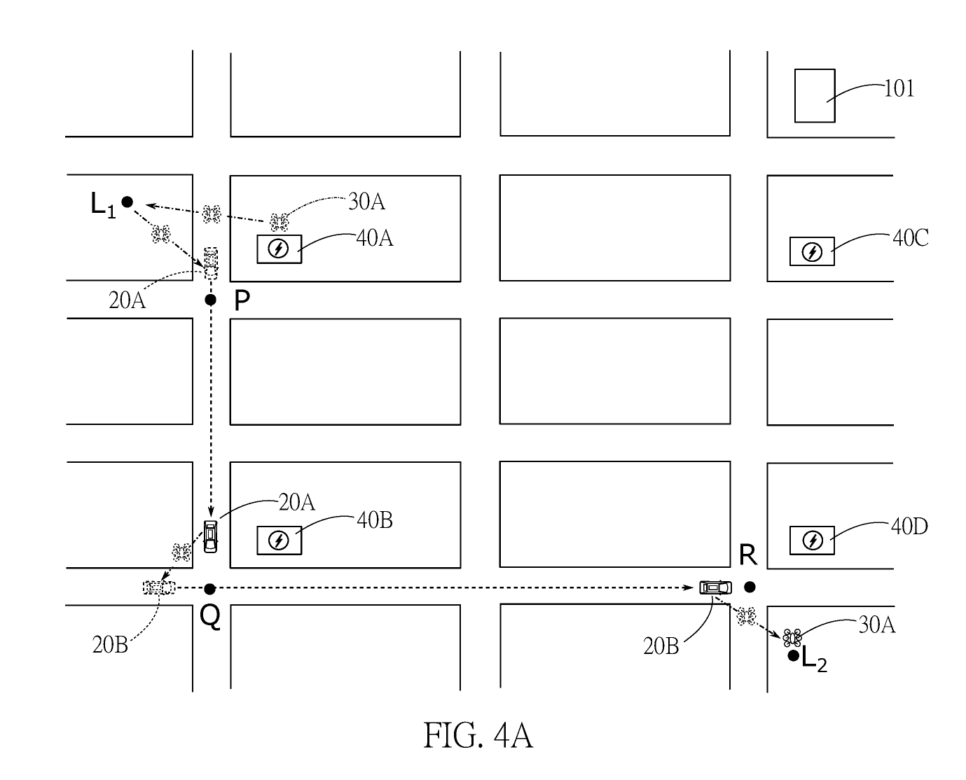

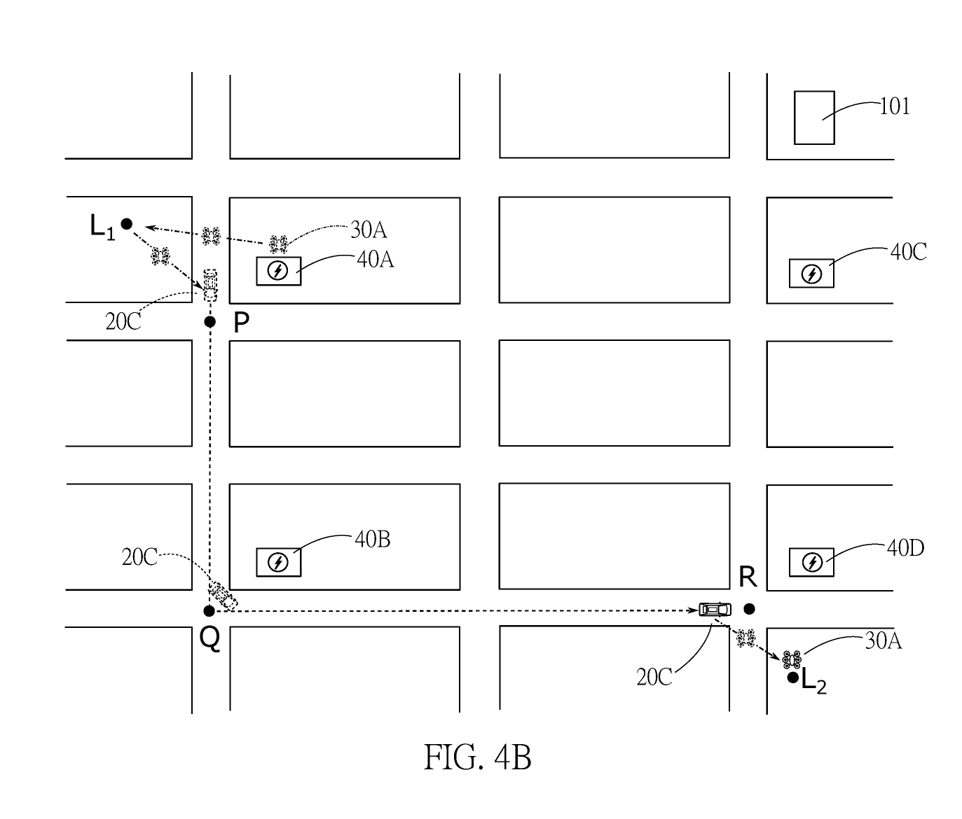

With reference to FIG. 4A, the user makes a request to the server at the 0^{th} minute, which requests to delivery the goods from a first location L₁ to a second location L₂. The first charging station 40A, the second charging station 40B, the third charging station 40C, the four charging station 40D, and the distribution center 101 are located in the area. The server finds the aerial machine 30A, which is closest to the first location L₁. Based on the obtained moving paths of the ground vehicles, the server starts to plan a delivery path. Based on the planned delivery path, the aerial machine 30A is expected to fly to the first location L₁ at 5^{th} minute. After the goods is picked up, the aerial machine 30A is expected to fly to a first connection point P to meet and to park on the first ground vehicle 20A at 10^{th} minute. The first connection P is the nearest connection point to the first location L₁. Then the first ground vehicle 20A carries the aerial machine 30A and arrives at a second connection point Q at 40^{th} minute. At the second connection point Q, the aerial machine 30A leaves the first ground vehicle 20A and flies to and parks on the second ground vehicle 20B. Then the second ground vehicle 20B carries the aerial machine 30A and arrives at a third connection point R at 70^{th} minute. The third connection point R is the nearest connection point to the second location L₂. At the third connection point R, the aerial machine 30A leaves the second ground vehicle 20B and flies to and arrives the second location L₂ at 75^{th} minute to finish the goods delivery.

### Ordinary Embodiment II

With reference to FIG. 4B, the user makes a request to the server at the 0^{th} minute, which requests to delivery the goods from a first location L₁ to a second location L₂. If the user indicates the cost is too much when the server report the delivery plan for the user to confirm, the user inputs the requirement to choose unlimited time but only to be willing to pay for only one ground vehicle. The server may keep receiving the moving paths of the ground vehicles to pair the delivery path. Then the server finds a third ground vehicle 20C that will pass through the first connection point P at 120^{th} minute and will pass through the third connection point R at 180^{th} minute. Then the delivery will be finish at 185^{th} minute. When the user confirms the revised delivery plan, the aerial machine 30A is expected to fly to the first location L₁ at 115^{th} minute. After the goods is picked up, the aerial machine 30A is expected to fly to the first connection point P to meet and to park on the third ground vehicle 20C at 120^{th} minute. Then the third ground vehicle 20C carries the aerial machine 30A and arrives at the third connection point R at 180^{th} minute. At the third connection point R, the aerial machine 30A leaves the third ground vehicle 20C and flies to and arrives the second location L₂ at 185^{th} minute to finish the goods delivery.

The previous ordinary embodiments I and II may be altered. If the server first report to the delivery plan as shown in the ordinary embodiment II to the user and the user indicates the delivery time is too long, the server may provide the delivery plan as shown in the ordinary embodiment I to the user. The initial delivery path provided by the server, the optimal delivery path can be planned according to the system parameter settings or the initial needs of the user. If the lowest cost is preferred, the server may provide the delivery plan of the ordinary embodiment II as shown in FIG. 4B as the optimal delivery plan. If the shortest delivery time is preferred, the server may provide the delivery plan of the ordinary embodiment I as shown in FIG. 4A as the optimal delivery plan. If the server is required to provide different options for the user to choose, the server may provide two ordinary embodiment as shown in FIGS. 4A and 4B for the user to choose.

### Re-Plan Embodiment I

The delivery plan as shown in FIG. 4A is executed and the user doe not require the delivery time for the goods to reach the second location L₂. However, at 20^{th} minute, the second ground vehicle 20B reports to the server that it cannot make the second connection point Q at 40^{th} minute due to some accident. Then the server needs to re-plan the delivery plan. The following description shows a re-plan embodiment I(i), a re-plan embodiment I(ii) and a re-plan embodiment I(iii). The re-plan embodiments I(i), I(ii) and I(iii) may be re-planned simultaneously and may be provided for the user to select, or may be executed in sequence according to the preset preference, or may be executed either one according to the preset preference. In one embodiment, if the second ground vehicle 20B changes the moving plan so that the second ground vehicle 20B cannot reach the second connection point Q, the server may transmit a warning massage to inform the second ground vehicle 20B that the original revenue should be lost after changing the moving path, and let the second ground vehicle 20B decide whether to maintain the original moving path within a predetermined time (such as 60 seconds).

### Re-Plan Embodiment I(i)

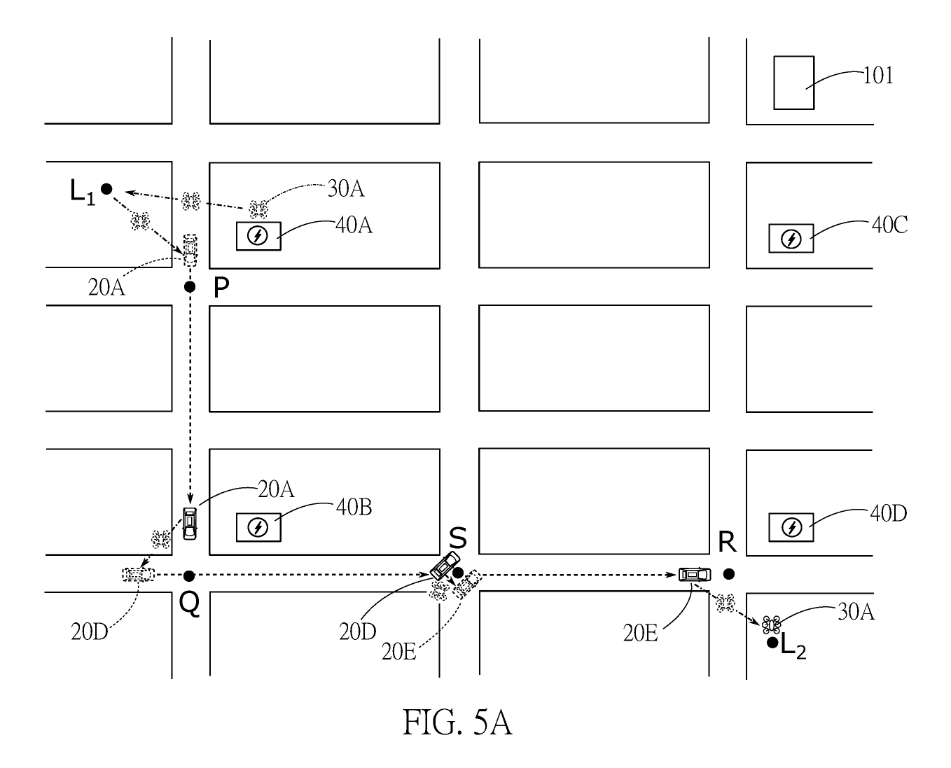

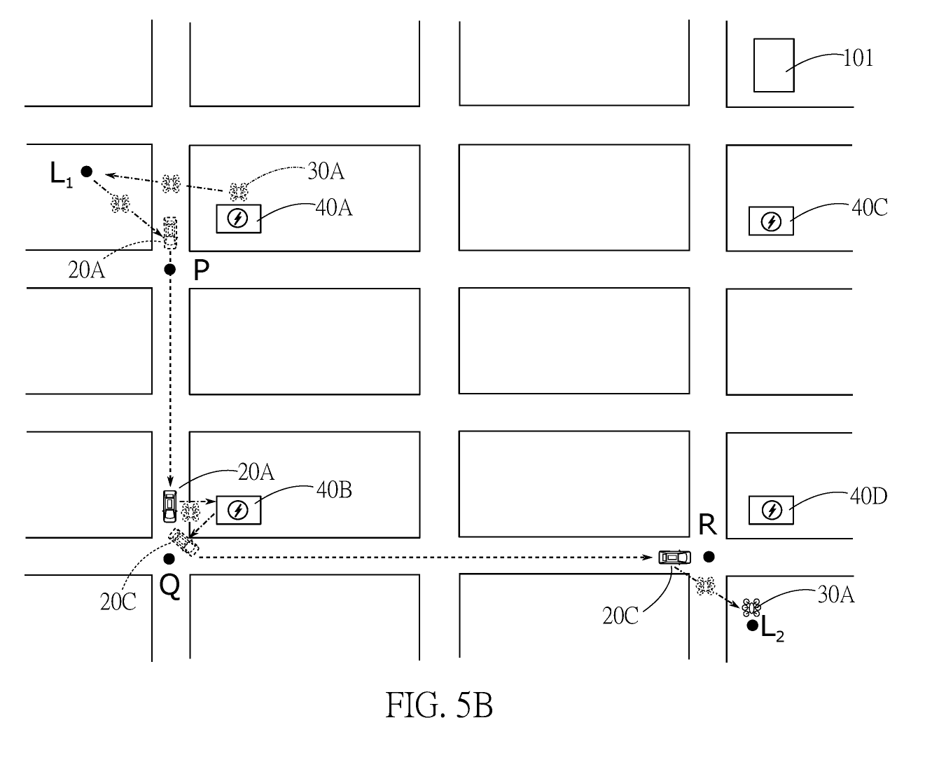

To re-execute the step S20 as shown in FIG. 2A, the know moving paths of the ground vehicles are paired to the planned delivery path again to find whether any moving path of any ground vehicle can substitute the original moving path of the second ground vehicle 20B. If two different substitution is found when the step S20 is executed again, the selection of the substitution may be based on the system parameter settings or the initial needs of the user. For example, a first substitution is shown as FIG. 5A, which includes that a fourth ground vehicle 20D arrives the second connection point Q at 60^{th} minute and arrives a fourth connection point S at 80^{th} minute, and a fifth ground vehicle 20E arrives the fourth connection point S at 80^{th} minute and arrives the third connection point R at 90^{th} minute, and then the delivery is finished at 95^{th} minute. A second substitution is shown as FIG. 5B, which includes that the third ground vehicle 20C arrives the second connection point Q at 90^{th} minute and arrives the third connection point R at 120^{th} minute, and then the delivery is finished at 125^{th} minute. Thus, if the system parameter settings or the initial needs of the user tends to choose a shortest delivery time, the first substitution as shown in FIG. 5A is chosen. If the system parameter settings or the initial needs of the user tends to choose a lowest cost, the second substitution as shown in FIG. 5B is chosen. In one embodiment, the server may still give the user to select the substitutions in a predetermined time (such as 60 seconds). In one embodiment, when the next ground vehicle does not arrive the connect point and the previous ground vehicle already leaves the connection point, the aerial machine 30A flies to and parks on the nearest charging station to stay and charge and waits for the next ground vehicle.

### Re-Plan Embodiment I(ii)

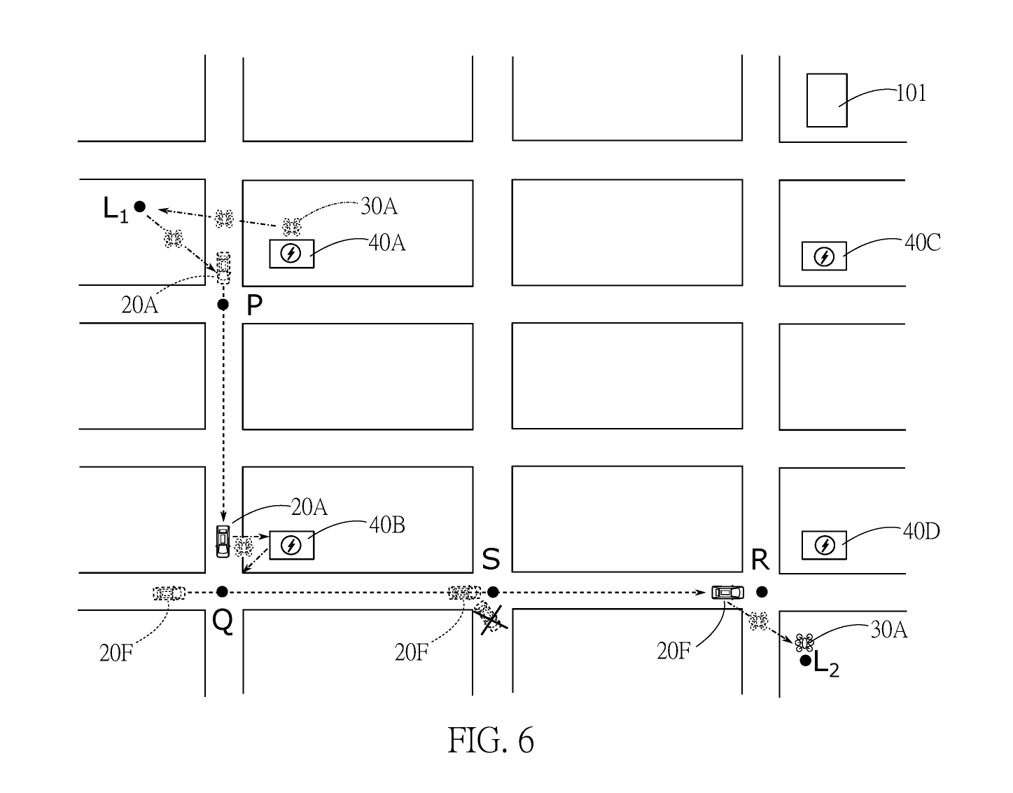

The step S41 as shown in FIG. 3 is executed to propose a moving path to a nearby ground and/or surface vehicle. After the nearby ground vehicle agrees, the nearby ground vehicle moves along the proposed moving path to compensate for the original moving path that the selected ground surface vehicle. With reference to FIG. 6, a sixth ground vehicle 20F is found and will pass the second connection point Q at 40^{th} minute, but the sixth ground vehicle 20F originally plan to turn right at the fourth connection point S instead of passing the third connection point R. The server proposes a moving path to the sixth ground vehicle 20F to suggest it to arrive the third connection point R at 70^{th} minute and provides an extra reward to the sixth ground vehicle 20F. When the sixth ground vehicle 20F in a predetermined time (such as 90 seconds), the substitution is executed.

### Re-Plan Embodiment I(iii)

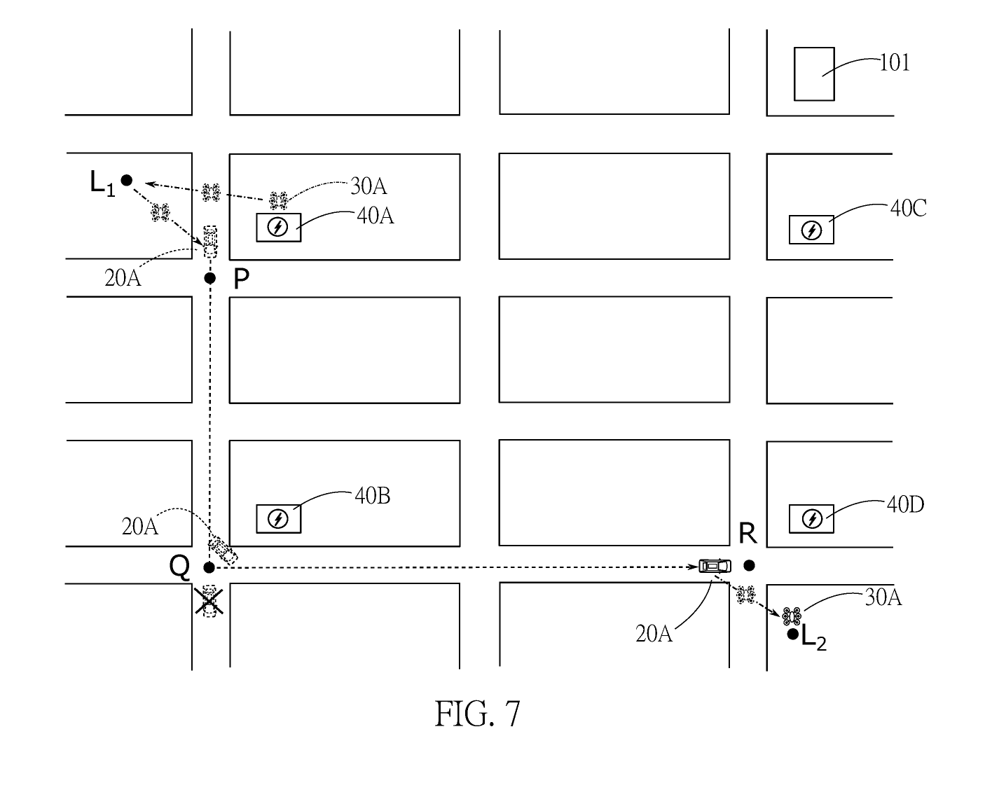

The step S42 as shown in FIG. 3 is executed, a moving path to the first ground vehicle 20A that is parked by the aerial machine 30A to compensate for the original moving path that the selected ground vehicle cannot move along. With reference to FIG. 7, the server proposes a moving path to the first ground vehicle 20A to suggest it to change it's original moving path when arriving the second connection point Q, and to turn left to arrive the third connection point R and provides an extra reward to the first ground vehicle 20A. When the first ground vehicle 20A in a predetermined time (such as 90 seconds), the substitution is executed and the delivery is still finished at 75^{th} minute.

If the substitutions as described in the re-plan embodiments I(i), I(ii), or I(iii) cannot be made before the first ground vehicle 20A passes the second connection point Q, the aerial machine 30A leaves the first ground vehicle 20A when the first ground vehicle 20A passes the second connection point Q and flies to and parks on the nearby second charging station 40B to wait for the re-plan. After the substituted plan is made, the aerial machine 30A leaves the second charging station 40B and meets with the next ground vehicle.

### Re-Plan Embodiment II

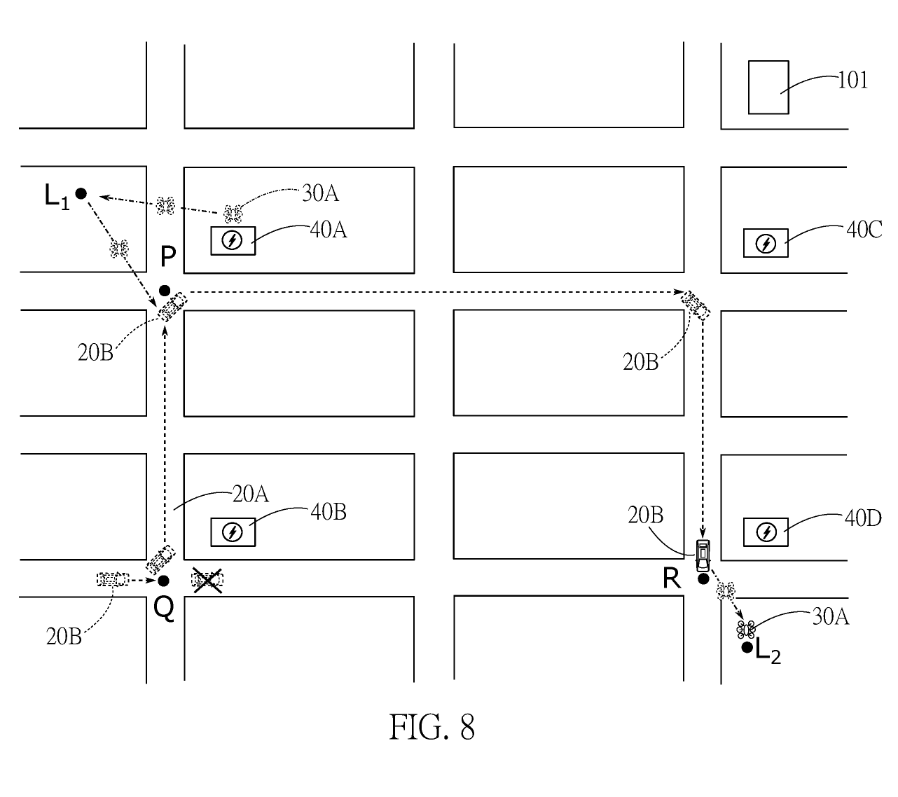

The deliver plan as shown in FIG. 4A is executed and the user does not request the delivery time. If the first ground vehicle 20A reports that it cannot reach the first connection point P at 10^{th} minute due to accident at the 3^{th} minute, the sever may re-plan the delivery path as the way described in the re-plan embodiments I(i), I(ii), or I(iii), or the sever may execute the step S43 as shown in FIG. 3 to propose a moving path to a next ground vehicle. If the next ground vehicle agrees to the proposed moving path, the next ground and/or surface vehicle moves along the proposed moving path to compensate for the original moving path that the first ground vehicle cannot move along. With reference to FIG. 8, the sever proposes a moving path to the second ground vehicle 20B to suggest it to change it's original moving path to arrive the first connection point P and to arrive the third connection point R and provides an extra reward to the first ground vehicle 20B. When the second ground vehicle 20B in a predetermined time (such as 90 seconds), the substitution is executed.

### Re-Plan Embodiment III

The deliver plan as shown in FIG. 4A is executed and the user requests the delivery time. If the second ground vehicle 20B reports that it cannot reach the second connection point Q at 40^{th} minute due to accident at the 20^{th} minute, the sever may re-plan the delivery path as the way described in the re-plan embodiments I(i) and I(ii). If the server cannot reach a delivery plan to deliver the goods to the second location L₂ in the requested time by re-planning the delivery path as the way described in the re-plan embodiments I(i) and I(ii), the sever may re-plan the deliver path as the way described in the re-plan embodiment I(iii). Alternatively, the sever may execute the step S44 as shown in FIG. 3 to demand the aerial machine 30A to leave the first ground vehicle 20A at the second connection point Q, and to fly to the second location L₂. Thus, the goods is delivered to the second location L₂ in the requested time.

### Return Path Plan Embodiment

The sever may plan the return path of the aerial machine 30A in advance. When the goods is delivered the second location L₂, the aerial machine 30A returns to the nearby stop such as the fourth charging station 40D. If the fourth charging station 40D is occupied, the aerial machine 30A may return to the third charging station 40C or the distribution center 101. In the previous embodiments, the aerial machine 30A parked on the first charging station 40A, which is the nearest charging station to the first location L₁, is assumed to be idle. Thus, the aerial machine 30A flies a short distance to reach the first location L₁ in the beginning. If the nearest idle aerial machine 30A is parked in the distribution center 101 or other charging stations, the server may also plans the path for the aerial machine 30A to reach the first location L₁, which includes to park on at least one ground vehicle that moves toward the first location L₁.

The advantages of the system and the method as described are recited as following. The navigation information of the ground and/or surface vehicles is used to pair with the delivery path of the goods so that the aerial machine can park on the ground and/or surface vehicles while deliver the goods. Thus, the power consumption of the aerial machine is saved to achieve the purpose of extending the distance of the goods that can be transported.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A goods transporting method using an aerial machine comprising steps of:
a. receiving a command for transporting goods, which includes a time for picking up the goods and a location for delivering the goods;
b. planning a delivery path of the goods based on the received command, and paring the planned delivery path with moving paths of multiple ground and/or surface vehicles to obtain a planned picking up time and a delivery time of the goods, wherein the planned deliver path includes a moving path of the aerial machine and a moving path of at least one selected ground and/or surface vehicle to overlap the moving path of the aerial machine with the moving path of at least one selected the ground and/or surface vehicle; and
c. executing the planned delivery path wherein the aerial machine begins to execute the planned delivery path by parking on and moving with the at least one selected ground and/or surface vehicle in at least partial of the planned delivery path.

2. The goods transporting method as claimed in claim 1 further comprising a step d executed after the step c, wherein the step d comprises acts of:
confirming whether a user agrees to the planned delivery path, and the planned picking up time and the delivery time of the goods in the step b;
executing the step c if the user agrees to the planned delivery path, and the planned picking up time and the delivery time of the goods in the step b; and
returning to the step b if the user disagrees to the planned delivery path, and the planned picking up time and the delivery time of the goods in the step b.

3. The goods transporting method as claimed in claim 2, wherein if the user disagrees to the planned delivery path, and the planned picking up time and the delivery time of the goods in the step b, the user is required to further input a modification command, which includes a cost range, a picking up time range, and/or a delivery time range; and when returning to the step b, a delivery path is planned according to the modification command.

4. The goods transporting method as claimed in claim 1, wherein the command for transporting goods includes a cost range, a picking up time range, and/or a delivery time range.

5. The goods transporting method as claimed in claim 1, wherein when one of the at least one selected ground and/or surface vehicle does not move along the planned delivery path or does not arrive a predetermined location in a predetermined time while executing the step c, the step b is executed again to plan a deliver path.

6. The goods transporting method as claimed in claim 1, wherein when one of the at least one selected ground and/or surface vehicle does not move along the planned delivery path or does not arrive a predetermined location in a predetermined time while executing the step c, nearby ground and/or surface vehicles are proposed a suggesting moving path to compensate the planned deliver path or the predetermined time that the one of the at least one selected ground and/or surface vehicle does not accomplished.

7. The goods transporting method as claimed in claim 1, wherein when one of the at least one selected ground and/or surface vehicle does not move along the planned delivery path or does not arrive a predetermined location in a predetermined time while executing the step c, the current ground and/or surface vehicle that the aerial machine parks on is proposed a suggesting moving path to compensate the planned deliver path or the predetermined time that the one of the at least one selected ground and/or surface vehicle does not accomplished.

8. The goods transporting method as claimed in claim 1, wherein when one of the at least one selected ground and/or surface vehicle does not move along the planned delivery path or does not arrive a predetermined location in a predetermined time while executing the step c, the next ground and/or surface vehicle is proposed a suggesting moving path to compensate the planned deliver path or the predetermined time that the one of the at least one selected ground and/or surface vehicle does not accomplished.

9. The goods transporting method as claimed in claim 1, wherein when one of the at least one selected ground and/or surface vehicle does not move along the planned delivery path or does not arrive a predetermined location in a predetermined time while executing the step c, the aerial machine flies along the planned delivery path to compensate the planned deliver path or the predetermined time that the one of the at least one selected ground and/or surface vehicle does not accomplished.

10. A goods transporting system with aerial machines comprising:
a server;
multiple ground and/or surface vehicles, wherein each ground and/or surface vehicle has
a navigation module instantaneously collecting location information and future moving path planning information of the ground and/or surface vehicle; and
a communication module providing the location information and the future moving path planning information of the ground and/or surface vehicle to the server;
multiple aerial machines, wherein each aerial machine has
a navigation module instantaneously collecting location information of the aerial machine; and
a communication module providing the location information of the aerial machine to the server;
wherein the server executes following steps:
a. receiving a command for transporting goods by the server, which includes a time for picking up the goods and a location for delivering the goods;
b. planning a delivery path of the goods by the server based on the received command, and paring the planned delivery path with the information received by the server to obtain a planned picking up time and a delivery time of the goods, wherein the planned deliver path includes a moving path of the aerial machine and a moving path of at least one selected ground and/or surface vehicle to overlap the moving path of the aerial machine with the moving path of at least one selected the ground and/or surface vehicle; and
c. executing the planned delivery path wherein one of the aerial machines begins to execute the planned delivery path by parking on and moving with the at least one selected ground and/or surface vehicle in at least partial of the planned delivery path.

11. The goods transporting system as claimed in claim 10, wherein the server further executes a step d after executing the step c, wherein the step d comprises acts of:
confirming whether a user agrees to the planned delivery path, and the planned picking up time and the delivery time of the goods in the step b;
executing the step c if the user agrees to the planned delivery path, and the planned picking up time and the delivery time of the goods in the step b; and
returning to the step b if the user disagrees to the planned delivery path, and the planned picking up time and the delivery time of the goods in the step b.

12. The goods transporting system as claimed in claim 11, wherein if the user disagrees to the planned delivery path, and the planned picking up time and the delivery time of the goods in the step b, the user is required to further input a modification command, which includes a cost range, a picking up time range, and/or a delivery time range; and when returning to the step b, a delivery path is planned according to the modification command.

13. The goods transporting system as claimed in claim 10, wherein the command for transporting goods includes a cost range, a picking up time range, and/or a delivery time range.

14. The goods transporting system as claimed in claim 10, wherein when one of the at least one selected ground and/or surface vehicle does not move along the planned delivery path or does not arrive a predetermined location in a predetermined time while executing the step c, the step b is executed again to plan a deliver path.

15. The goods transporting system as claimed in claim 10, wherein when one of the at least one selected ground and/or surface vehicle does not move along the planned delivery path or does not arrive a predetermined location in a predetermined time while executing the step c, nearby ground and/or surface vehicles are proposed a suggesting moving path to compensate the planned deliver path or the predetermined time that the one of the at least one selected ground and/or surface vehicle does not accomplished.

16. The goods transporting system as claimed in claim 10, wherein when one of the at least one selected ground and/or surface vehicle does not move along the planned delivery path or does not arrive a predetermined location in a predetermined time while executing the step c, the current ground and/or surface vehicle that the aerial machine parks on is proposed a suggesting moving path to compensate the planned deliver path or the predetermined time that the one of the at least one selected ground and/or surface vehicle does not accomplished.

17. The goods transporting system as claimed in claim 10, wherein when one of the at least one selected ground and/or surface vehicle does not move along the planned delivery path or does not arrive a predetermined location in a predetermined time while executing the step c, the next ground and/or surface vehicle is proposed a suggesting moving path to compensate the planned deliver path or the predetermined time that the one of the at least one selected ground and/or surface vehicle does not accomplished.

18. The goods transporting system as claimed in claim 10, wherein when one of the at least one selected ground and/or surface vehicle does not move along the planned delivery path or does not arrive a predetermined location in a predetermined time while executing the step c, the aerial machine flies along the planned delivery path to compensate the planned deliver path or the predetermined time that the one of the at least one selected ground and/or surface vehicle does not accomplished.
